(19) United States
(12) Patent Application Publication
(10) Pub. No.: US 2015/0352913 A1
(43) Pub. Date: Dec. 10, 2015

(54) NON-SLIP INFLATABLE DEVICE FOR MOTOR VEHICLE TYRES

(71) Applicant: Benito DE PAZ UCEDO, (US)

(72) Inventor: Benito de Paz, Madrid (ES)

(21) Appl. No.: 14/762,206

(22) PCT Filed: May 31, 2013
(86) PCT No.: PCT/ES2013/070352

§ 371 Date: Jul. 21, 2015

(30) Foreign Application Priority Data
May 9, 2013 (ES) U201330554

(51) Int. Cl. B60C 27/06; B60C 27/20

(52) U.S. Cl. CPC B60C 27/06; B60C 27/20

(57) ABSTRACT

The invention relates to a non-skid device for tyres of motor vehicles, of those formed from a device which covers the tread of the tyre and has, on the outer face thereof, elements which convert it into a non-skid device, and characterised in that the device itself consists of a resistant element having a short, toroidal shape, where the non-skid elements are arranged on the outer face of the device, and the lower outer face is in contact with the outer face of the tyre, and comprising small polyhedral elements and inner reinforcements consisting of lugs of resistant material, also having a valve for inflating the device.

### PURPOSE OF THE INVENTION

The invention proposed refers to a non-slip inflatable device for motor vehicle tyres consisting of a component that covers the tyre tread on whose external surface there are elements to make it non-slip. Said device is secured to the tyre under pressure as the device is inflated.

### FIELD OF THE INVENTION

The field of the invention is that of manufacturers of motor vehicle accessories, and is of utility within the motor vehicle sector.

### BACKGROUND OF THE INVENTION

There are some predecessors of the system described in these specifications, but all those examined are mechanical in nature and in no case has the existence been noted of any device of a pneumatic nature which can be removed immediately.

The inventor is unaware of any forerunner incorporating the elements in this invention nor the benefits brought by said elements.

### DESCRIPTION OF THE INVENTION

The invention proposed refers to a non-slip inflatable device for motor vehicle tyres of the sort consisting of a device overlaying the tyre tread and which has elements on its external face which make it non-slip. Said device is attached to the tyre under pressure when the device is inflated, and the device as such consists of a resistant, low-rise, toroid element revealing an external surface of the device in the form of a tread on which the non-slip elements can be seen. Said non-slip elements, protecting the device's tread and secured on the outside of said device, are made of plates whose external area contains non-slip elements such as nails, pyramids or any other element which may fulfil a non-slip function in friction on ice, snow or mud surfaces.

On the outside lower face, which is in contact with the external surface of the tyre, and to ensure that the device is not moved by the effect of the running of the tyre, protuberances are provided on said outside lower face of the device, one of which, inserted in the tyre grooves, will prevent the device from moving.

The device includes an inflation valve so that, when the device is deflated, it is easy to slide along the tyre tread to place it in its working position and, once in that position, with the aid of a gas bottle or manual pump, the valve is used to inflate the device, which is secured in its working position.

The side surfaces of the device, while not in principle in contact with any abrasive surface, must be sufficiently strong so that, once the device is inflated, running does not cause them to lose their shape outwards, causing the unit to lose its dynamic characteristics.

Said device may also be fitted with attachment tabs on the resistant side surfaces and which can be used to moor external tightening elements should this be necessary, to secure the device.

Inside the device there are internal reinforcements in the form of lugs made of resistant material and located all around the circumference of the device and of sufficient height to prevent the two sides of the device from coming into contact, possibly losing their characteristics.

Said reinforcements, of variable dimensions, will never impede the circulation of the inflating air pressure.

### DESCRIPTION OF THE DRAWINGS

For a better understanding of the invention, a page of plans is attached showing the following:

FIG. 1.—A lateral diagrammatic view of the device.

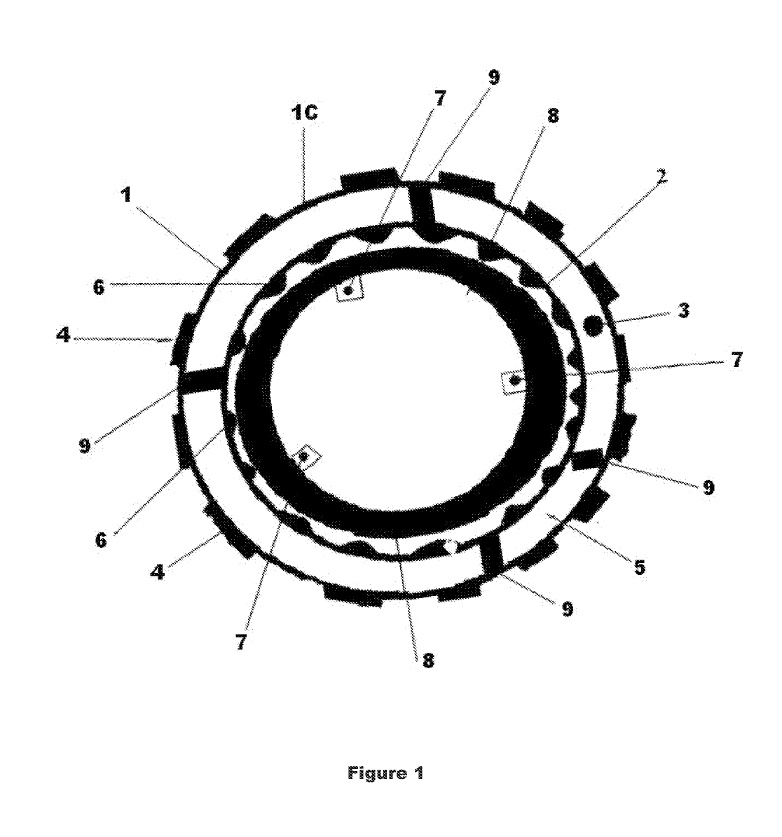

Identical components are denominated in said FIGURE with the same reference, among which the following may be distinguished:

(1).—outside face,

(2).—outside lower face,

(3).—inflation valve,

(4).—non-slip external protectors,

(5).—resistant side surfaces,

(6).—interior protuberances,

(7).—securing tabs,

(8).—tyre,

(9).—interior reinforcements,

### A PREFERENTIAL EMBODIMENT OF THE INVENTION

The invention proposed refers to a non-slip inflatable device for motor vehicle tyres of the sort comprising a device that covers the tyre tread and which has elements on its outside surface to make it non-slip. Said device is secured to the tyre under pressure when the device is inflated, said device itself made of a resistant, low-rise, toroid element where the following elements can be made out:

(1).—the outside surface of the device like a tread on which the non-slip elements are visible:

(2).—the lower outside surface, in contact with the outside surface of the tyre (8).
To prevent the device from moving as a result of the effect of the running of the tyre, protuberances (6) are included on said lower outside surface (2) of the device one of which, inserted in the grooves of the tyre (8), will prevent the device from moving.

(3).—inflation valve.
The device has an inflation valve so that, when said device is deflated t is easy to slide along the tyre tread, to move it into its working position.
Once in its working position, the device is fixed in its working position with the aid of a gas bottle or manual pump, through the valve.

(4).—exterior non-slip protectors.
These protectors, secured on the outside of the device (19) consist of plates with non-slip elements on their outside, such as nails, pyramids or any other element which may fulfil a non-slip function in friction on ice, snow or mud surfaces.

(5).—Resistant side surfaces.
The side surfaces of the device, while not in principle in contact with any abrasive surface, must be sufficiently strong so that, once the device is inflated, running does not cause them to lose their shape outwards, causing the unit to lose its dynamic characteristics.

(6).—internal protuberances for attachment to the outside surface of the tyre (8), in the for of small polyhedral resistant elements able to fit into the grooves of a standard tyre.

(7).—connecting tabs on the resistant side surfaces (5) to attach external tightening components if needed to secure the device.

(9).—internal reinforcements on the device, consisting of resistant material lugs located around the entire circumference of the device and high enough to prevent the two faces of the device coming into contact and possibly losing their characteristics.
Said reinforcements, of variable dimensions, will never prevent the circulation of the inflating air pressure.

Having sufficiently described the nature of the invention and its practical implementation, it must be recorded that the foregoing specifications represented in the attached drawings may be modified in detail, provided that does not alter their fundamental principles pursuant to the previous paragraphs and summarised in the following claims.

1. A non-slip inflatable device for motor vehicle which covers the tread of the tyre and which has elements on its outside surface making it non-slip, and characterised because the device as such is made of a resistant, low-rise, toroid element, where the following elements can be observed:
(1).—the outside surface of the device, which is like a tread on which the non-slip elements are visible.
(2).—the lower outside surface, in contact with the outside surface of the tyre (8).
(3).—inflation valve. There is an inflation valve for the device so that, when said device is deflated, it is easy to slide along the tyre tread, to move it into its working position.
Once in its working position, the device is fixed in its working position with the aid of a gas bottle or manual pump, through the valve.
(4).—exterior non-slip protectors.
These protectors, secured on the outside of the device (1) consist of plates with non-slip elements on their outside, such as nails, pyramids or any other element which may fulfil a non-slip function in friction on ice, snow or mud surfaces.
(5).—resistant side surfaces. The side surfaces of the device, while not in principle in contact with any abrasive surface, must be sufficiently strong so that, once the device is inflated, running does not cause them to lose their shape outwards.
(6).—internal protuberances for attachment to the outside surface of the tyre (8), in the form of small polyhedral resistant elements able to fit into the grooves of a standard tyre.
(7)—connecting tabs on the resistant side surfaces (5) to attach external tightening components.
(9).—internal reinforcements on the device, consisting of resistant material lugs located around the entire circumference of the device and high enough to prevent the two faces of the device coming into contact.
